(19) United States
(12) Patent Application Publication
(10) Pub. No.: US 2002/0016732 A1
(43) Pub. Date: Feb. 7, 2002

(54) Open research and development method and system

(76) Inventor: Akihiro Teramachi, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/871,605

(22) Filed: Jun. 1, 2001

(30) Foreign Application Priority Data
Jun. 2, 2000 (JP) 2000-165667

(51) Int. Cl. G06F 17/60

(52) U.S. Cl. 705/10

(57) ABSTRACT

An open research and development method includes the steps of: sending membership solicitation information to a communications network from a predetermined server; causing an applicant for membership to report predetermined items from a network terminal operated by the applicant, by way of the communications network; performing examination operation on the reported information in connection with membership registration; registering the information about the applicant into a membership database on at least the condition that the applicant should have passed the examination operation; and accumulating, into a knowledge database, information which has been transmitted from members registered in the membership database by way of the communications network in relation to a specific topic.

### BACKGROUND OF THE INVENTION

1. Field of the Invention

The present invention relates to a method and system for carrying out research and development (hereinafter simply called “R&D”) operations by utilization of a communications network.

2. Description of the Related Art

Various types of systems for exchanging a variety of types of information items by way of the Internet have been proposed and put into practical use. Information items related to scientific technologies have been the subject matter handled by some of these systems. There has already been realized a system which preserves various types of engineering information items in the form of a database and which enables downloading of required information from the data base by way of the Internet, free of charge or on a chargeable basis. There has also been proposed a system wherein previously-registered information providers are called on to provide information over the Internet; the provided information is evaluated; and a reward commensurate with a result of evaluation is offered to the information provider (as described in, e.g., Japanese Patent Application Laid-Open No. 101635/2000).

In connection with R&D activities of corporations, the number of cases utilizing so-called outsourcing, such as some R&D work being commissioned to outside institutions, is increasing. An exchange of information through the Internet yields an advantage of the ability to gather information from throughout the world in real time. Hence, utilization of such an exchange of information over the Internet for outsourcing may enable rationalization of R&D operation and an improvement in efficiency of R&D operation.

An exchange of information over the Internet involves an indefinite number of information providers, thereby posing a problem of great variations in the value of information provided. For this reason, when an information-gathering system is established by utilization of the Internet, cataloging and evaluation of gathered information involves consumption of much time and effort, thus entertaining a fear of worsening efficiency.

In the system described in Japanese Patent Application Laid-Open No. 101635/2000, keywords pertaining to information which information providers can offer are registered in a database, and providers to be called on to provide information are narrowed by utilization of the keyword. Since no particular limitations are imposed on registration of information providers into a database, persons of various backgrounds are also registered in the database. Accordingly, variations in the value of information provided still remain.

### SUMMARY OF THE INVENTION

The present invention has been conceived to provide a method and system which enable efficient collection of valuable information by utilization of a communications network and pursuit of R&D operations.

In order to facilitate comprehension of the present invention, reference symbols employed in the accompanying drawings are provided in the following descriptions in a parenthesized form. The present invention is not limited to the illustrated embodiment.

The present invention provides an open research and development method comprising the steps of:

sending membership solicitation information to a communications network (1) from a predetermined server (3);

causing an applicant for membership to report predetermined items from a network terminal (10) operated by the applicant, by way of the communications network;

performing examination operation on the reported information in connection with membership registration;

registering the information about the applicant into a membership database (7) on at least the condition that the applicant should have passed the examination operation; and

accumulating, into a knowledge database (8), information which has been transmitted from members registered in the membership database by way of the communications network in relation to a specific topic. The previously-described problems are solved by the method.

According to the present method, an applicant for membership is caused to report predetermined items. Membership registration of the applicant is examined on the basis of the thus-reported items. Hence, examination requirements are set such that only applicants of a level desired by an operator can pass the examination, thus limiting registration of members. As a result, the quality of members can be converged on a desired range. Accordingly, provision of information of a certain quality level or more can be expected. Efforts required for cataloging or classifying offered information are saved, as a result of which efficiency of collection of information is improved. Since an examination system is employed for determining membership registration, there can be prevented useless bloating of a membership data base, which would otherwise be caused by an indiscriminate increase in the number of members. Accordingly, useless consumption of the capacity of medium for storing a membership database can be prevented, thus enabling high-speed retrieval operation and easy multiplexing of data. Thus, handling of the membership database can be made easy. An applicant who has passed the examination may be registered as members immediately. Alternatively, a pass in the examination may be reported to an applicant, and the applicant may be registered as members with the consent of the applicant. As a precondition for membership registration, any conditions maybe submitted to an applicant who has passed the examination. The applicant maybe registered as a member only if the applicant has accepted the conditions. Further, applicants who have passed the examination may be ranked into several levels in accordance with, e.g., an examination result.

Under the research and development method according to the present invention, members to be requested to provide information are selected by utilization of information pertaining to the members registered in the membership database (7). A request for providing engineering information may be sent to the thus-selected members by way of the communications network. In this case, prospective members who are expected to provide promising information are further narrowed, and a request for providing information may be sent to the thus-narrowed members. As a result, there is a high probability of a further increase arising in the value of information offered in response to the request.

Given inquiries may be submitted to the applicant by way of the communications network, and a determination may be made as to whether or not the applicant is registered as a member, on the basis of answers provided in response to the inquiries. As a result, the qualification of each of applicants can be determined in a predetermined manner, on the basis of a tendency of answers to inquiries which have been prepared in advance. The reliability of examination of personal quality using a computer can be enhanced.

Preferably, the items to be reported by the applicant may include items to be used for grasping the applicant's experience in research and development. In this case, persons suitable for the research and development work outsourced from a corporation can be registered as members.

Preferably, a secrecy memorandum may be concluded with the applicant who has passed the examination operation, by way of the communications network, and membership registration of the applicant may be admitted only if the applicant has concluded the secrecy memorandum.

In this case, a secrecy memorandum is concluded with members by way of the communications network. Hence, information pertaining to confidential matters of a corporation can be exchanged between members. Even in connection with matters important for pursuing research and development, a project can be efficiently pursued in partnership with members by utilization of the network.

Preferably, the Internet maybe used as the communications network, and the membership solicitation information may be sent to the Internet from a WWW server.

As a result, information can be gathered from all over the world by utilization of the WWW system of the Internet. Collection of knowledge and handling of a work load, which cannot be realized by a limited number of persons in a corporation, can be realized readily on a global scale.

The present invention also provides an open research and development system comprising:

means (3) for sending membership solicitation in formation to a communications network (1);

means (3) for sending items to be reported at time of application for membership to a network terminal (10) operated by an applicant, by way of the communications network;

means (3) for acquiring the items which are transmitted from the network terminal by way of the communications network and for performing an examination in connection with membership registration on the basis of the received information;

means (3, 5) for registering the information about the applicant into a membership database (7) at least on condition that the applicant has passed the examination; and

means (3, 8) for accumulating, into knowledge database, information which pertains to a certain topic and which has been sent from a member registered in the membership database by way of the communications network.

Preferably, the open research and development system may further comprise means (5) for selecting members for which provision of information is to be requested, by utilization of information about the members registered in the membership database; and means (4) for requesting the selected members to offer engineering information by way of the communications network. Preferably, the means (3) for sending items to be reported at the time of application for membership may submit given inquiries to the applicant by way of the communications network, and the means (3) for performing an examination may perform an examination on the basis of answers provided in response to the inquiries. Preferably, the items to be reported for application by the applicant may include items to be used for grasping the applicant's experience in research and development. Preferably, the open research and development system may further comprise means (3) for submitting a secrecy memorandum to the applicant who has passed the examination operation, by way of the communications network; and means (3) for determining whether or not the applicant has agreed on conclusion of the secrecy memorandum on the basis of the information transmitted from the network terminal in response to the submitted secrecy memorandum, wherein registration of the applicant into the membership database is admitted only if the applicant has concluded the secrecy memorandum. Preferably, the communications network may correspond to the Internet, and the membership solicitation information may be sent from a WWW server via the Internet.

### BRIEF DESCRIPTION OF THE DRAWINGS

FIG. 1 is an illustration showing an example of a network system to which the present invention is applied;

FIG. 2 is a flowchart showing the outline of procedures for gathering information according to the present invention;

FIG. 3 is an illustration showing an example of a home page for soliciting membership registration and provision of information by way of the Internet;

FIG. 4 is an illustration showing an example of a form for entering information to be reported at the time of membership registration;

FIGS. 5A and 5B are illustrations showing an example of form to be used for reporting a result of membership examination to an applicant;

FIG. 6 is an illustration showing an example of an E-mail used for requesting members to provide information;

FIGS. 7A and 7B are illustrations showing an example of a Web page used for calling on members to provide information;

FIG. 8 is an illustration showing an example of an E-mail used for reporting a result of evaluation of provided information to a member;

FIG. 9 is a flowchart showing procedures used for registering a member;

FIG. 10 is a flowchart showing procedures along which an operator request members to provide information;

FIG. 11 is a flowchart showing procedures along which a member offers information; and

FIG. 12 is a flowchart showing procedures for evaluating the information offered by a member and reporting a result of evaluation of the information to the member.

### DETAILED DESCRIPTION OF THE PREFERRED EMBODIMENTS

Now, a description will be given in more detail of preferred embodiments of the invention with reference to the accompanying drawings.

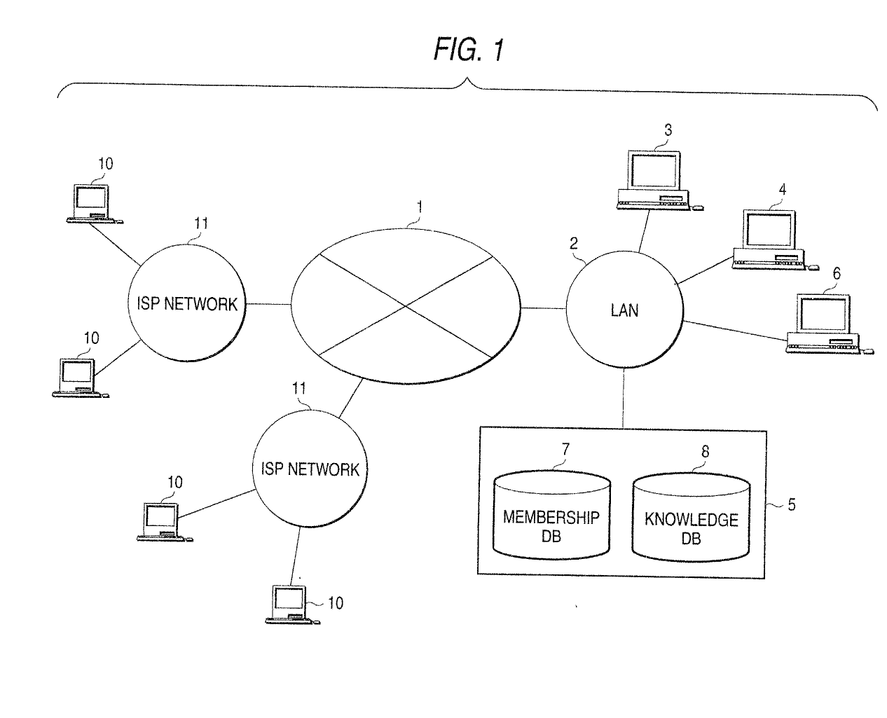

FIG. 1 shows an example of an open research and development system according to the present invention. The system utilizes the Internet 1. A LAN 2 constitutes a portion of the Internet 1. A business operator who desires to gather engineering information by means of the present system (hereinafter called an “operator”) connects to the LAN 2, as means for providing a predetermined service by way of the Internet 1, a WWW server 3, a mail server 4, and a database server S, for example. A terminal 6 is also connected to the LAN 2 for managing the servers 3 through 5. The database server 5 holds a membership database (the term “database” is abbreviated as “DB” in the drawings) 7 for managing the present system, and a knowledge database 8. A service desired by a client is provided from the system.

A person who desires to provide engineering information to the operator can access the WWW server 3 from a user terminal 10 by way of the Internet 1. The user terminal 10 is constituted by utilization of, e.g., a personal computer. Any type of terminal device, such as a portable cellular phone or a network home appliance, may be used as the user terminal 10, so long as the terminal device has the function of exchanging information over the Internet 1. The user terminal 10 is connected to the Internet 1 by way of a network (ISP network) 11 operated by, e.g., a commercial provider, by utilization of a dial-up connection service provided by the provider. Connection of the user terminal 10 and the Internet 1 is not limited to only the dial-up IP connection, but may also be realized by means of a private line IP connection. Alternatively, the user terminal 10 and the LAN 2 may be connected by any of various methods.

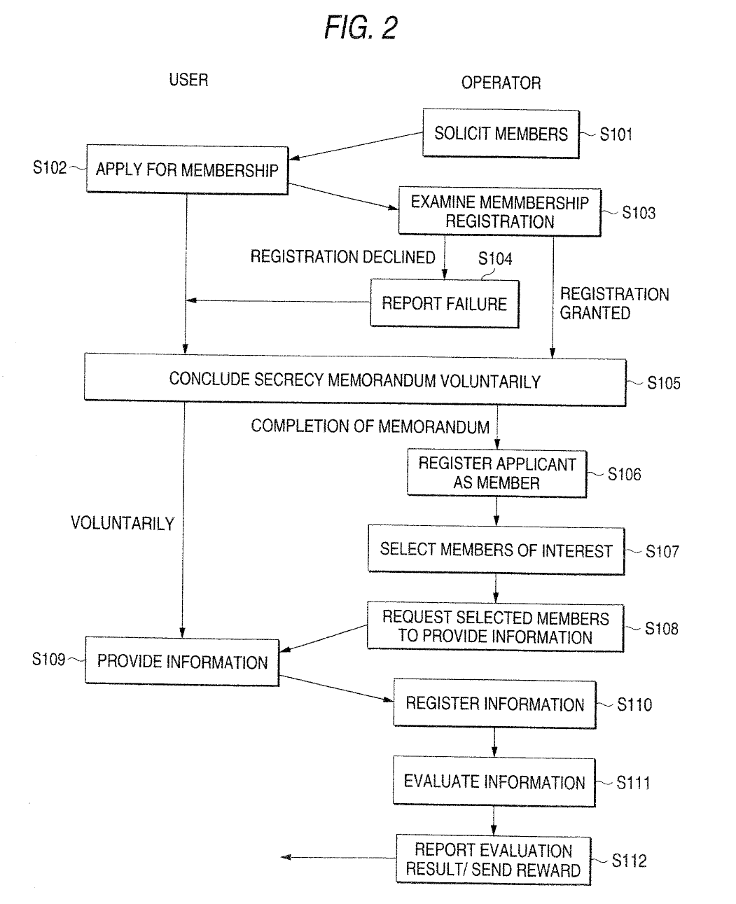

FIG. 2 is a flowchart showing the outline of procedures for gathering information by means of the present system. Processing provided on the right-side portion of the drawing sheet is to be performed on the LAN 2 of the operator. Operations for gathering information to be performed by the present system are divided into steps of soliciting members (steps S101 through S106) and steps of soliciting engineering information from the members (steps S107 through S112).

In the steps of soliciting membership, solicitation of members is transmitted from the operator by way of the Internet (step S101). When a user reports to the operator predetermined items (items for specifying an applicant; e.g., a name, an address, and a phone number, and items for specifying the engineering field of and the development experience of the applicant) (step S102), the operator examines the thus-reported items with regard to membership registration (step S103). If registration of the applicant has been declined as a result of examination, a message to this effect is sent to the applicant (step S104). In contrast, when registration of the applicant has been allowed, a secrecy memorandum is concluded between the operator and the applicant by way of the Internet 1 (step S105). If the secrecy memorandum has been concluded, the applicant is registered as a member in the membership database 7 (step S106). In order to enable selection of members, the items which have been reported at the time of application are also registered at the time of membership registration. The persons who have been allowed through examination are classified into a plurality of ranks according to the result of examination. Handling of members may be differentiated according to ranks. Thus, the steps for registering members are now completed.

When the operator requires engineering information about a specific engineering topic, members who are considered to be able to deal with the topic are chosen from the membership database 7 (step S107). A request for providing information is issued to the thus-selected members (step S108). The members can provide information in response to the request (step S109). Even when no request is issued, members can voluntarily provide engineering information. The operator records the thus-offered information into the knowledge database 8 (step S110) and evaluates the value of the thus-offered information through a predetermined process (step Sill). After evaluation of the information, the result of evaluation is reported to the member, and compensation commensurate with the evaluation result is paid to the member (step S112). Depending on the evaluation result, the member may be issued a request for participating as a staff member in an engineering development project pursued by the operator. Participation may assume the form of full participation or limited participation. Further, a workplace can also be set freely. For instance, a location convenient for the member, such as his or her home, can be admitted as a workplace by utilization of a network.

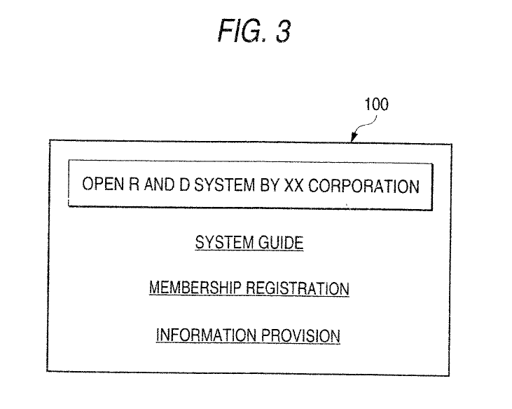

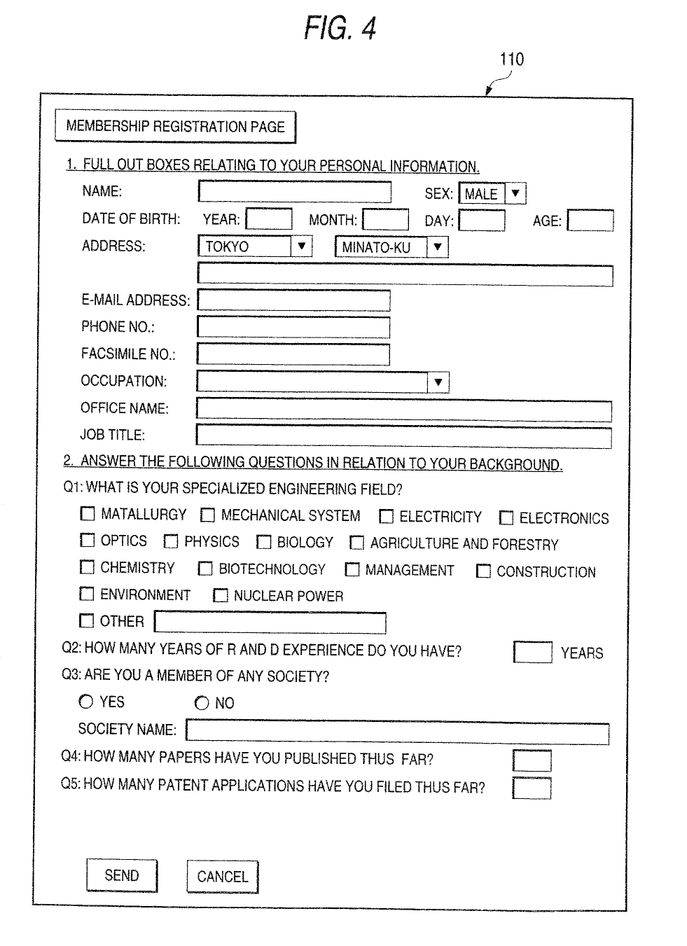

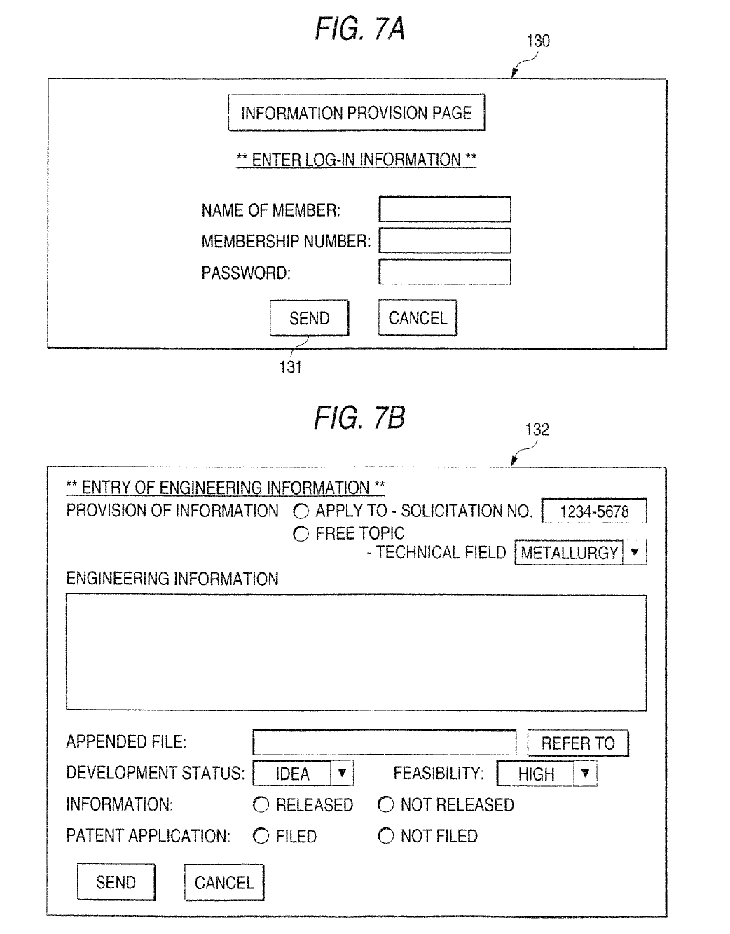

By reference to FIGS. 3 through 12, procedures for operating the present system will be described in more detail. FIG. 3 illustrates a home page of the present system which appears when access is made to the WWW server 3. A user launches a browser on his terminal 10 and enters a predetermined URL, to enable display of a home page 100 shown in FIG. 3 on a monitor of the terminal 10. Character strings “System Guide, ” “Membership Registration,” and “Provision of Information” are provided in the home page 100. The character string “System Guide” is linked so as to jump to a page (not shown) for describing the outline of the system. The character string “Membership Registration” is linked so as to jump to a page 110 (see FIG. 4) for membership registration. The character string “provision of Information” is linked so as to jump to a page (see FIGS. 7A and 7B) for registering engineering information.

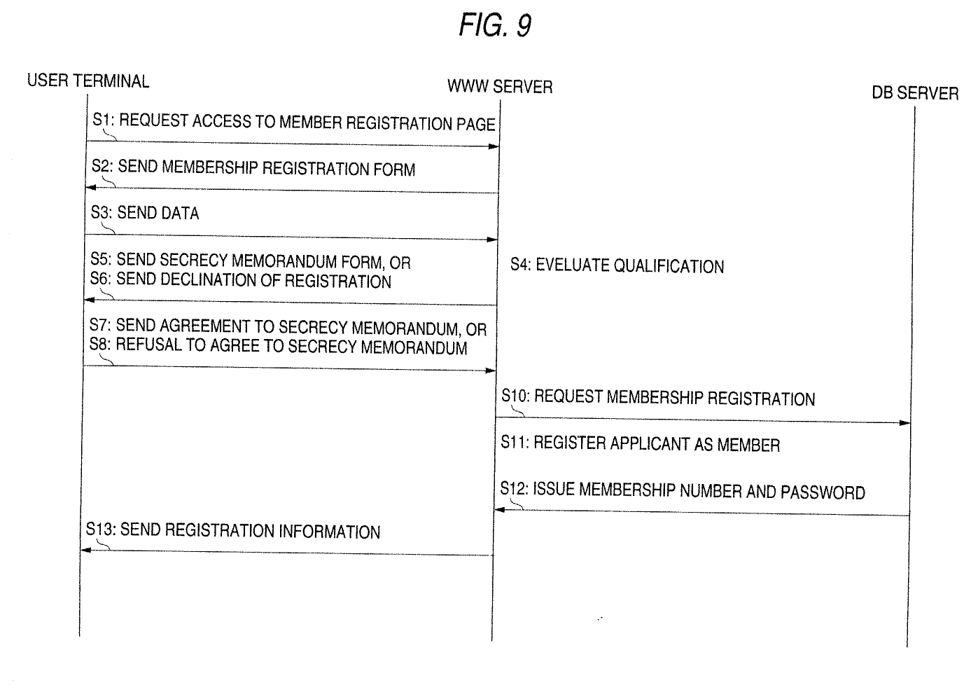

When the user clicks the character string “Membership Registration” through actuation of the terminal 10, membership registration processing is effected between the user terminal 10, the WWW server 3, and the database server 5 in accordance with procedures shown in FIG. 9. First, as a result of “Membership Registration” shown in FIG. 3 being clicked, information for requesting access to a membership registration page 110 is transmitted from the user terminal 10 to the WWW server 3 (step S1). Upon receipt of the information, the WWW server 3 transmits, to the user terminal 10 that has issued the information, data to be used for displaying the membership registration page (i.e., a membership registration form) 110 (step S2). As a result, the membership registration page 110 shown in FIG. 4 appears on the monitor of the user terminal 10.

The membership registration page 110 includes a part for entering personal information, such as the name and address of the applicant, and a part for inquiring about items required for grasping R&D experience of the applicant, in the form of inquiries. Communication between the system operator and the applicant over the Internet 1 is feasible, and hence personal information to be filled out by the applicant preferably includes the applicant's E-mail address. Items required for grasping R&D experience maybe appropriately selected in accordance with the object of operation of the system. The items may include, for example, a technical field, the number of years of R&D experience, the number of academic papers published, and the number of patent applications filed. In order to facilitate implementation of automatic qualification examination using a computer, a multiple-choice format may preferably be employed, in which an appropriate answer is to be selected from alternatives provided in advance.

When the applicant clicks a transmission button 111 after having filled out required items on the membership registration page 110, data corresponding to the thus-entered items are transmitted from the user terminal 10 to the WWW server 3 (step S3) On the basis of received data, the WWW server 3 identifies the items entered by the applicant, there by making an examination as to whether or not the applicant has satisfied qualification requirements of a member in accordance with a predetermined standard (step S4). At this time, the R&D experience of the applicant is determined on the basis of the answers to the questions provided on the membership registration page 110. If the system is configured so as to decline membership registration of an applicant who has failed to satisfy a predetermined level of R&D experience (e.g., because of having less than three years' experience), the system can be operated with an eye on only persons having given engineering knowledge, thereby enabling efficient acquisition of highly-valuable engineering information. Qualification examination may be effected by transferring data from the WWW server 3 to another computer A (e.g., an operator terminal 6).

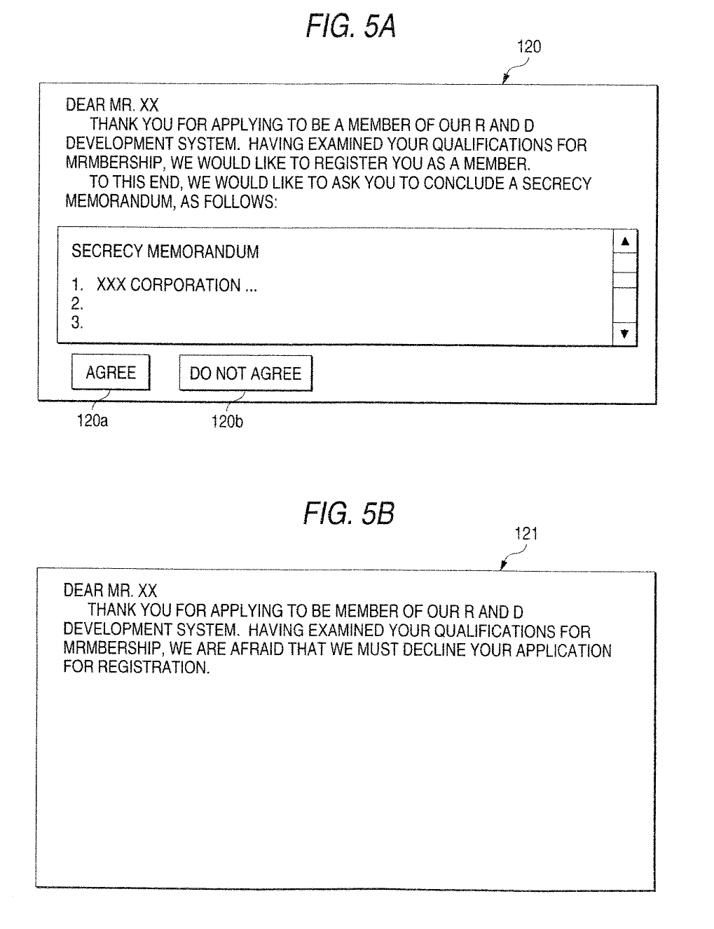

After examination of qualification of the applicant has been completed, a result of examination is reported to the user terminal 10 from the WWW server 3. For example, when membership registration of the applicant is granted, data to be used for displaying a secrecy memorandum form 120 shown in FIG. 5A on the user terminal 10 are transmitted (step S5). In contrast, if membership registration of the applicant is to be declined, a form 121 for reporting a failure to attain membership registration is transmitted to the user terminal 10 (step S6)

When the secrecy memorandum form 120 has appeared on the user terminal 10, the user can ascertain details of the secrecy memorandum on the monitor screen of the terminal 10 through actuation of the terminal 10. The secrecy memorandum imposes on the operator and members an obligation not to leak information acquired through the system.

When the user clicks an agreement button 120a of the form 120 after having agreed to the secrecy memorandum, the fact that the user has agreed to the secrecy memorandum is reported to the WWW server 3 by the user terminal 10 (step S7). In contrast, if the user has declined to agree to the secrecy memorandum and has clicked a refusal to agree button 120b of the form 120, the user's refusal to agree to the secrecy memorandum is reported to the WWW server 3 by the user terminal 10 (step S8).

When the agreement on the secrecy memorandum has been reported, a request for registering the applicant who has concluded the secrecy memorandum as a member is sent from the WWW server 3 to the database server 5 (step S10). Upon receipt of the request, the database server 5 registers the applicant as a member (step S11). Membership registration is achieved by means of registering in the membership database 7, as information about the member, the items filled in by the applicant in response to membership solicitation. This enables narrowing of the information providers to only members having an R&D experience matching an object, such as calling on only members in specific engineering field to provide information.

After completion of membership registration, a membership number and a password, which are to be used for authenticating the thus-registered member in the system, are issued from the database server 5 to the WWW server 3 (step S12). Upon receipt of the membership number and the password, the WWW server 3 sends the membership number and the password to the user terminal 10 in conjunction with information indicating that membership registration has been completed (step S13). The password may be freely set by the user.

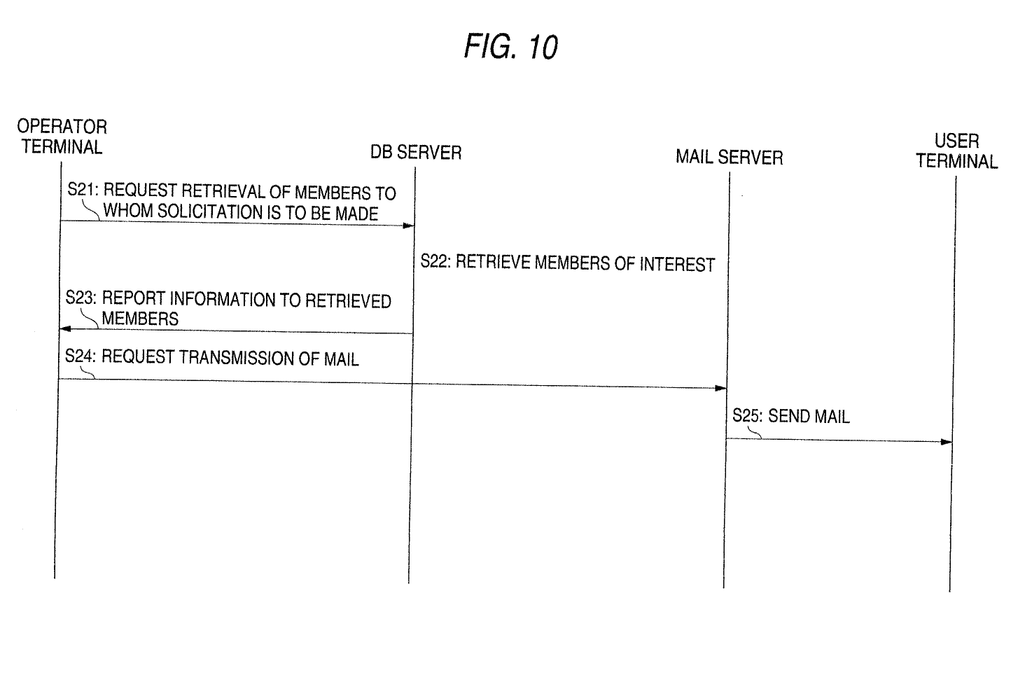

FIG. 10 shows procedures through which the operator requests members to provide engineering information. When attempting to gather engineering information, the operator actuates the operator terminal 6, thereby enabling entry of conditions for extracting from the membership database 7 members suitable for soliciting engineering information. After entry of the conditions, a retrieval request is sent from the operator terminal 6 to the database server 5 for extracting from the membership database 7 members satisfying the conditions (step S21). Having received the retrieval request, the database server extracts from the membership database 7 members satisfying the conditions, by means of retrieval (step S22). The members who have been extracted through retrieval are reported to the operator terminal 6 (step S23).

Having received the report, the operator terminal requests the mail server 4 to send a predetermined E-mail to the thus-extracted members (step S24). In response to the request, the mail server 4 sends an E-mail to the members extracted in step S22 (step S25). E-mail addresses of the members have already been reported at the time of membership registration and recorded in the membership database 7.

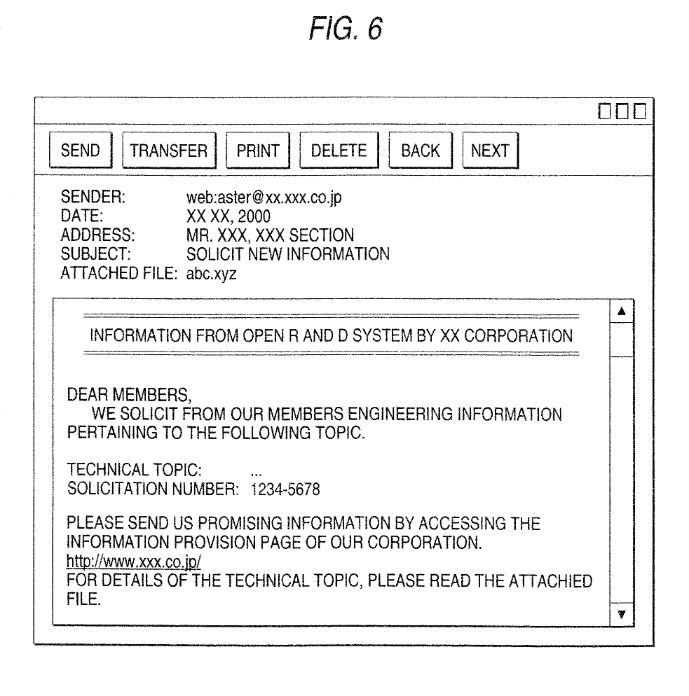

The E-mail to be transmitted is formatted, as shown in, e.g., FIG. 6. The basic format of the E-mail is prepared by, e.g., the operator terminal 6, in advance. The main body of an E-mail is completed by the operator filling out the item provided on the form (e.g., a solicited technical topic). In order to classify engineering information items offered by members according to solicited technical topics, E-mails for soliciting, e.g., engineering information, are desirably assigned solicitation numbers. If an engineering topic to be solicited cannot be represented within a limited number of words of an E-mail, an electronic E-mail is transmitted while a separately-prepared file is attached to the E-mail. Provision of engineering information in response to a request by an E-mail maybe effected by use of, e.g., a return mail. Alternatively, there may be utilized an information provision page appearing when the character string “Provision of Information” on the home page 100 shown in FIG. 3 is clicked. In this case, providing a URL to be used for accessing the information provision page in the main body of the E-mail is desirable. [0036]

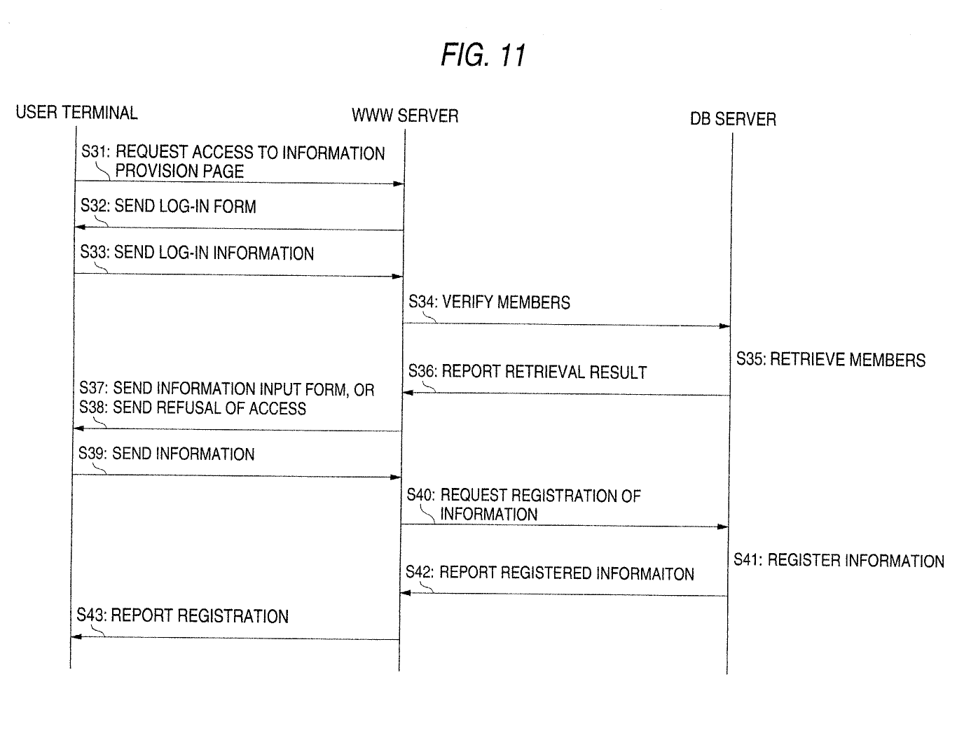

FIG. 11 shows procedures providing engineering information by utilization of an information provision page. When a member operating the terminal 10 clicks the character string “Provision of Information” on the start page 100 shown in FIG. 3 or when the member directly accesses a URL described on the information provision page by use of a browser, the WWW server 3 is requested to access the information provision page (step S31). Upon receipt of the request, the WWW server 3 sends a log-in form to the terminal 10 that has sent the request (step S32). As a result, a log-in form 130 such as that shown in FIG. 7A appears on the terminal 10.

When the member clicks a transmission button 131 after having filled out a name, a membership number, and a password provided in the form 130, the terminal 10 sends log-in information to the WWW server 3 (step S33). Upon receipt of the log-in information, the WWW server 3 acquires information about the member from the database 5 on the basis of the log-in information (step S34). The database 5 retrieves a member matching the given log-in information from the membership database 7 (step S35). A result of retrieval is sent to the WWW server 3 (step S36). When a member matching the log-in information is found, the WWW server 3 sends a predetermined information input form to the user terminal 10 (step S37). In contrast, if a member matching the log-in information is not found, a refusal of access to the information provision page is sent to the terminal 10 (step S36). As mentioned above, entry of log-in information prevents provision of information from a person not having membership. Hence, the quality of information provided from members is held at a certain level, thereby enhancing the value of information and frequency of utilization of the information.

When processing pertaining to step S37 is performed, an information input form 132 shown in FIG. 7B appears on the user terminal 10. A member enters information to be offered by utilization of the form 132 or can specify, as an attached file, a file explaining information to be offered. In order for the operator to determine whether information has been offered from a member for application to the solicitation of information made by the E-mail shown in FIG. 6 or has been voluntarily provided from a member irrelevant to the solicitation of information, the form 132 may desirably be provided with an entry for clarifying the object of provision of information. In the illustrated embodiment, a member clicks an item “application” when offering information in answer to the solicitation made by the operator. If information is offered voluntarily, a member clicks “free topic.” Thus, the nature of provision of information can be determined. Further, in order to facilitate narrowing, cataloging, and classification of provided information, a member enters a solicitation number assigned to the E-mail shown in FIG. 6 when offering information in response to a solicitation. In contrast, a member selects a technical field on a form 132 in which information is to be offered, when voluntarily offering information.

When a member clicks a transmission button 133 after having filled out required items on the form 132, entered information is sent from the terminal 10 to the WWW server 3 (step S39). Upon receipt of the information, the WWW server 3 sends the thus-offered engineering information to the database server 5, thus requesting registration of the engineering information into the knowledge database 8 (step S40). The database server 5 which has received the request registers the engineering information in a predetermined format (step S41) and sends information (e.g., a registration number) corresponding to a registration result to the WWW server 3 (step S42). The WWW server 3 that has received the information informs the terminal 10 that the offered engineering information has been registered (step S43).

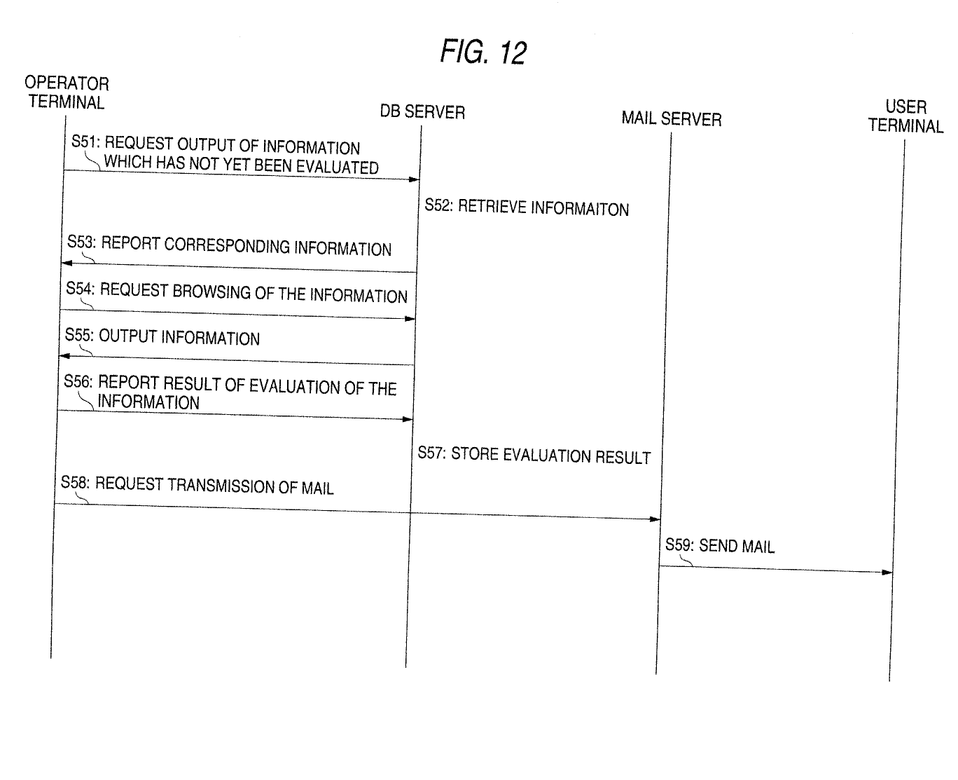

FIG. 12 shows procedures for evaluating the engineering information offered from members. When the operator retrieves unevaluated engineering information by actuation of the operator terminal 6, the operator terminal 6 requests the database server 5 to output unevaluated engineering information (step S51). Upon receipt of the request, the database server 5 retrieves unevaluated engineering information from the knowledge database 8 (step S52). In accordance with a retrieval result, the database server 5 reports corresponding information (i.e., unevaluated engineering information) to the operator terminal 6 (step S53). In this phase, for example, a list of unevaluated engineering information pieces may be displayed on the operator terminal 6.

When the operator specifies engineering information desired to browse from the list by actuation of the operator terminal 6, the operator terminal 6 requests the database server 5 to browse the thus-specified engineering information (step S54). The database server 5 outputs the thus-specified engineering information to the operator terminal 6. The operator ascertains the thus-output engineering information on a monitor of the operator terminal 6 or ascertains the engineering information after having printed the information. The operator evaluates the engineering information in accordance with predetermined evaluation standards, and an evaluation result is input to the operator terminal 6.

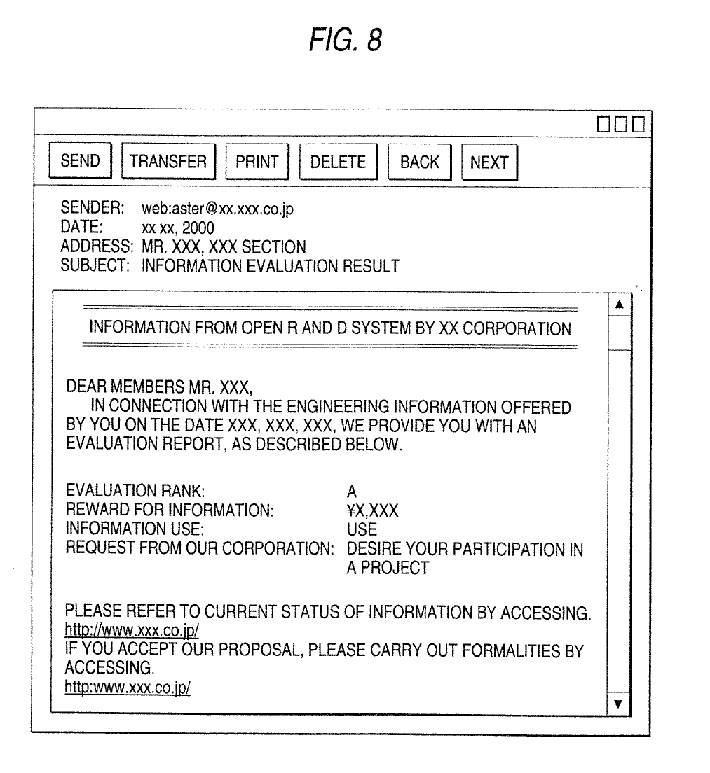

After entry of the evaluation result, the operator terminal 6 sends the evaluation result to the database server 5 (step S56). The database server 5 that has received the evaluation result stores the evaluation result in association with the engineering information that has been evaluated (step S57) In parallel with registration of the evaluation result, the operator terminal 6 requests the mail server 4 to send an E-mail to the member who has offered the engineering information that has been evaluated (step S58). The mail server 4 sends an E-mail to the member (step S59). The E-mail reports the result of evaluation of the engineering information to the member who has offered the engineering information and is configured, as shown in, e.g., FIG. 8. The main body of the E-mail shown in FIG. 8 includes the result of technical evaluation of the information, a reward for the information, and information as to whether or not the engineering information has already been used by the operator. In some occasions, the E-mail indicating the evaluation result further includes the operator's desire for participation of the member (to e.g., a project). In this case, for example, the manner of participation into a project is reported to the member, or a page for determining details about a style of participation is prepared on the WWW server 3. Further, an URL of the page is described in the main body the E-mail, thereby enabling the member to readily answer to the operator's desire.

After participation of the member, a conceivable method of pursuing research and development is a discussion. In this case, a rapport between members which have participated the project is required. For instance, such a rapport can be established by utilization of, e.g., a bulletin board on the Internet. Alternatively, individual participants of the project exchange information, and exchange of information may be managed by a person other than the operator, so long as the product of research and development can be achieved in the end. Moreover, participants access the knowledge database or another database provided separately from the knowledge database, thereby attempting to share information.

Through the foregoing processing, the operator calls on members to provide information and reports a result of evaluation of engineering information to a member, through use of an E-mail. Properly speaking, the E-mail is sent to a mail server employed by the user. Alternatively, such a report is not limited to an electronic mail and may be sent on a WEB or by way of a facsimile. Naturally, security measures utilizing an encryption technology are taken against exchange of various types of information pieces.

The present invention is not limited to the embodiment and may be susceptible to various embodiments. For instance, a communications network is not limited to the Internet. A LAN or IAN intended for specific persons maybe employed instead of the Internet. Further, the present invention may be connected to an intranet established globally. The server of the operator may be changed variously in accordance with details of a LAN.

As has been described, in the present invention, an applicant for membership is caused to report predetermined items, and registration of membership is determined on the basis of the thus-reported items. Hence, membership registration can be granted for only applicants at a level desired by the operator. Hence, the quality of members can be maintained at a certain level or more. Accordingly, it can be expected that information of certain level or higher is provided from members. Thus, research and development can be pursued by utilization of a communications network and efficiently absorbing valuable information.

What is claimed is:

1. An open research and development method comprising the steps of:
sending membership solicitation information to a communications network from a predetermined server;
causing an applicant for membership to report predetermined items from a network terminal operated by the applicant, by way of the communications network;
performing examination operation on the reported information in connection with membership registration;
registering the information about the applicant into a membership data base on at least the condition that the applicant should have passed the examination operation; and
accumulating, into a knowledge database, information which has been transmitted from members registered in the membership database by way of the communications network in relation to a specific topic.

2. The open research and development method according to claim 1, further comprising the steps of:
selecting members for which provision of information is to be requested, by utilization of information about the members registered in the membership database; and
requesting the selected members to offer engineering information by way of the communications network.

3. The open research and development method according to claim 1, further comprising the steps of:
submitting given inquiries to the applicant by way of the communications network; and
determining whether to register the applicant as a member, on the basis of answers provided in response to the inquiries.

4. The open research and development method according to anyone of claims 1 through 3, wherein the items to be reported by the applicant include items to be used for grasping the applicant's experience in research and development.

5. The open research and development method according to claim 1, further comprising the steps of:
concluding a secrecy memorandum with the applicant who has passed the examination operation, by way of the communications network; and
admitting membership registration of the applicant only if the applicant has concluded the secrecy memorandum.

6. The open research and development method according to claim 1, wherein the communications network corresponds to the Internet, and the membership solicitation information is sent from a WWW server via the Internet.

7. An open research and development system comprising:
means for sending membership solicitation information to a communications network;
means for sending items to be reported at time of application for membership to a network terminal operated by an applicant, by way of the communications network;
means for acquiring the items which are transmitted from the network terminal by way of the communications network and for performing an examination in connection with membership registration on the basis of the received information;
means for registering the information about the applicant into a membership database at least on condition that the applicant has passed the examination; and
means for accumulating, into knowledge database, information which pertains to a certain topic and which has been sent from a member registered in the membership database by way of the communications network.

8. The open research and development system according to claim 7, further comprising:
means for selecting members for which provision of information is to be requested, by utilization of information about the members registered in the membership database; and
means for requesting the selected members to offer engineering information by way of the communications network.

9. The open research and development system according to claim 7, wherein the means for sending items to be reported at the time of application for membership submits given inquiries to the applicant by way of the communications network; and the means for performing an examination performs an examination on the basis of answers provided in response to the inquiries.

10. The open research and development system according to claim 7, wherein the items to be reported for application by the applicant include items to be used for grasping the applicant's experience in research and development.

11. The open research and development system according to claim 7, further comprising:
means for submitting a secrecy memorandum to the applicant who has passed the examination operation, by way of the communications network; and
means for determining whether or not the applicant has agreed on conclusion of the secrecy memorandum on the basis of the information transmitted from the network terminal in response to the submitted secrecy memorandum, wherein registration of the applicant into the membership database is admitted only if the applicant has concluded the secrecy memorandum.

12. The open research and development system according to claim 7, wherein the communications network corresponds to the Internet, and the membership solicitation information is sent from a WWW server via the Internet.
